(19) United States
(12) Patent Application Publication
(10) Pub. No.: US 2009/0084782 A1
(43) Pub. Date: Apr. 2, 2009

(54) Method and Apparatus for Sealing an Enclosure

(75) Inventor: Clifford Randy Helmer, Fulton, NY (US)

Correspondence Address: KING & SPALDING, LLP, 1100 LOUISIANA ST., STE. 4000, ATTN.: IP Docketing, HOUSTON, TX, 77002-5213, US

(73) Assignee: Cooper Technologies Company, Houston, TX (US)

(21) Appl. No.: 12/179,693

(22) Filed: Jul. 25, 2008

Related U.S. Application Data
(63) Continuation-in-part of application No. 11/370,286, filed on Mar. 8, 2006, now abandoned.

(51) Int. Cl. H02G 3/14

(52) U.S. Cl. 220/3.8; 53/485; 174/564

(57) ABSTRACT

An apparatus and method according to which a seal is provided between an enclosure and an enclosure cover. The enclosure cover includes an enclosure engagement surface for coupling to enclosure. The apparatus includes a gasket positioned in a gasket channel located on the enclosure engagement surface to provide a seal between the enclosure and the enclosure cover. The enclosure engagement surface also includes a flame path surface adjacent the gasket channel.

### CROSS-REFERENCE TO RELATED APPLICATIONS

The present application is a continuation-in-part of U.S. patent application Ser. No. 11/370,286, titled “Method and Apparatus for Sealing an Enclosure” and filed on Mar. 8, 2006, in the name of Clifford Randy Helmer, the entire disclosure of which is hereby fully incorporated herein by reference.

### TECHNICAL FIELD

The present disclosure relates in general to enclosures and in particular to a method and apparatus for sealing an enclosure.

### BACKGROUND

Explosion-proof receptacle housings may be coupled to an enclosure (or back box) that is mounted to a wall, beam, or rack. These explosion-proof receptacle housing and enclosure systems may be used, for example, in military applications, shipboard, automotive industries, oil refineries and petrochemical plants, and other harsh environments. However, conventional explosion-proof receptacle housing and enclosure systems are not NEMA 4 rated, i.e. they are not hose-tight. In addition, when a receptacle housing must be replaced, or as receptacles are improved upon, many of these receptacle housings cannot be retrofit to an existing enclosure while maintaining the integrity of the required flame path dimension by Underwriters Laboratory (UL) standards.

Therefore, a need exists for an improved receptacle housing and enclosure system that is NEMA 4 rated. Another need exists for an improved method of retrofitting an explosion-proof receptacle housing to an existing enclosure system while maintaining the required UL flame path dimension.

### SUMMARY OF THE INVENTION

The present invention relates to an explosion-proof receptacle housing that can be retrofit to an existing enclosure. The receptacle housing and enclosure system is NEMA 4 rated.

In certain aspects, the invention provides a receptacle housing having an enclosure cover. The enclosure cover is configured to couple to a conventional back box enclosure via an enclosure engagement surface. The enclosure cover can include a gasket channel located on the enclosure engagement surface. A gasket is positioned in the gasket channel and can create a hose-tight seal between the enclosure and the enclosure cover. The enclosure engagement surface can also include a flame path surface adjacent the gasket channel. In some aspects, the flame path surface has a minimum width of ⅜ of an inch.

These and other aspects, objects, features and embodiments of the present invention will become apparent to those skilled in the art upon consideration of the following detailed description of illustrated embodiments exemplifying the best mode for carrying out the invention as presently perceived.

### BRIEF DESCRIPTION OF THE DRAWINGS

FIG. 1a is a perspective view illustrating an exemplary embodiment of an enclosure cover.

FIG. 1b is a cross sectional view illustrating an exemplary embodiment of the enclosure cover of FIG. 1a.

FIG. 1c is a bottom view illustrating an exemplary embodiment of the enclosure cover of FIG. 1a.

FIG. 2a is a perspective view illustrating an exemplary embodiment of an enclosure used with the enclosure cover of FIGS. 1a, 1b, and 1c.

FIG. 2b is a cross sectional view illustrating an exemplary embodiment of the enclosure of FIG. 2a.

FIG. 3a is a bottom view illustrating an exemplary embodiment of a gasket used with the enclosure cover of FIGS. 1a, 1b, and 1c and the enclosure of FIGS. 2a and 2b.

FIG. 3b is a cross sectional view illustrating an exemplary embodiment of the gasket of FIG. 3a.

FIG. 4a is a flow chart illustrating an exemplary embodiment of a method for sealing an enclosure.

FIG. 4b is an exploded view illustrating an exemplary embodiment of the assembly of the enclosure cover of FIGS. 1a, 1b, and 1c, the enclosure of FIGS. 2a and 2b, and the gasket of FIGS. 3a and 3b.

FIG. 4c is a cross sectional view illustrating an exemplary embodiment of the enclosure cover, the enclosure, and the gasket of FIG. 4b coupled together.

FIG. 5a is an side view illustrating an exemplary experimental embodiment of the enclosure cover, the enclosure, and the gasket of FIGS. 4b and 4c with a receptacle coupled to the enclosure cover.

FIG. 5b is an top view illustrating an exemplary experimental embodiment of the enclosure cover, the enclosure, the gasket, and the receptacle of FIG. 5a.

FIG. 5c is an cross sectional view illustrating an exemplary experimental embodiment of the enclosure cover, the enclosure, the gasket, and the receptacle of FIG. 5b.

### DETAILED DESCRIPTION

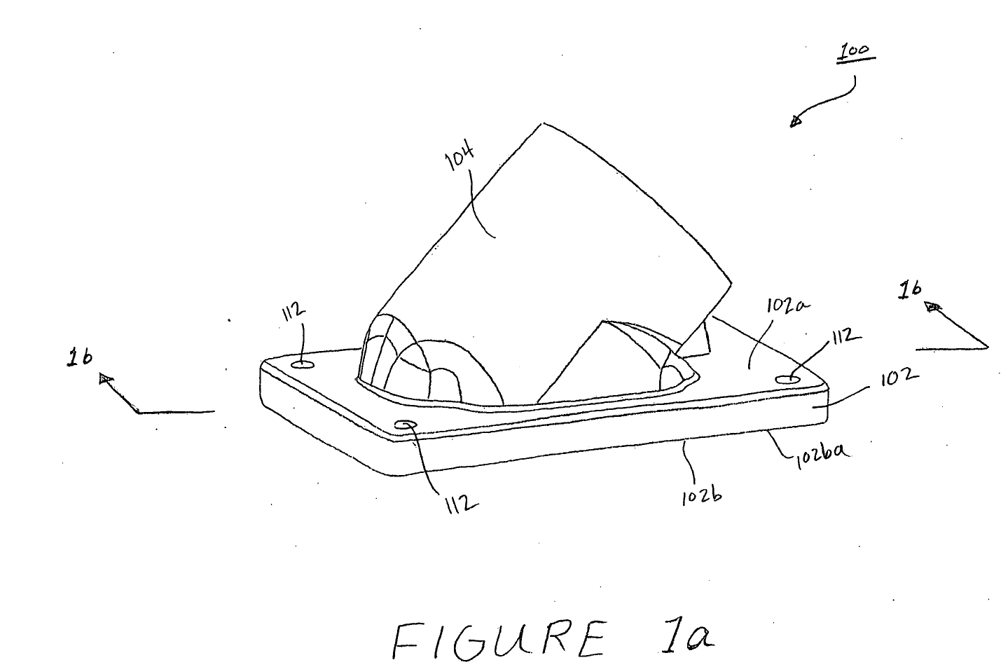

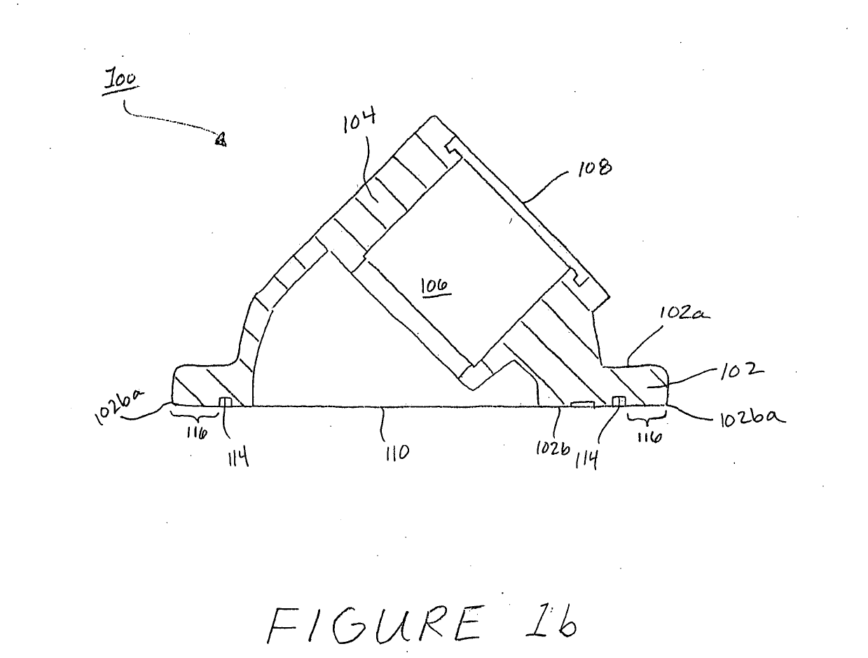

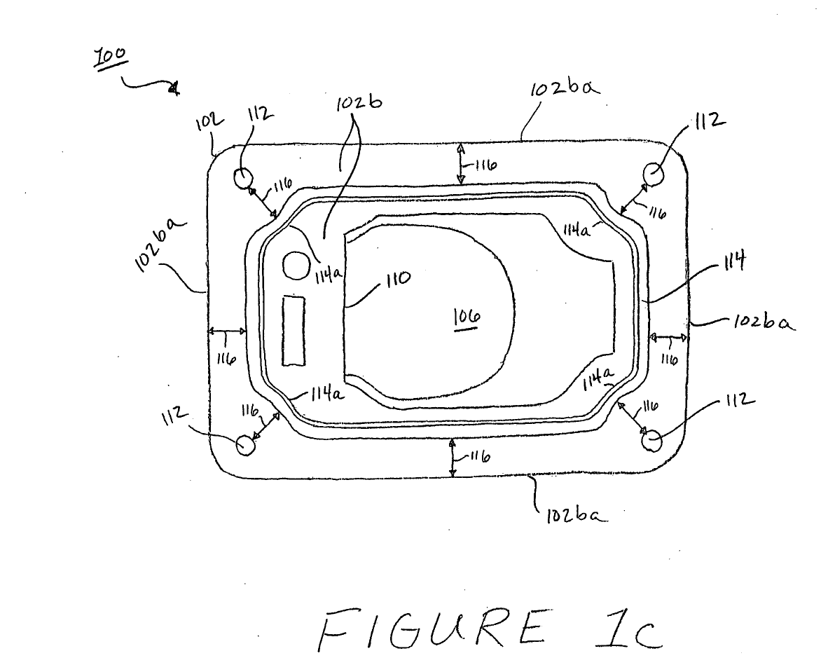

Referring now to FIGS. 1a, 1b, and 1c, an enclosure cover 100 is illustrated. The enclosure cover 100 includes a base 102 having a top surface 102a and a enclosure engagement surface 102b located opposite the top surface 102a. In an embodiment, the enclosure cover 100 is fabricated from a metallic material such that the enclosure engagement surface 102b includes a metal surface. The enclosure engagement surface 102b includes an enclosure engagement surface edge 102ba about its perimeter. A receptacle member 104 extends from the top surface 102a of the base 102 and defines a receptacle housing 106 along its length. A receptacle entrance 108 is defined by the receptacle member 104, is located on an end of the receptacle member 104 opposite the base 102, and provides access to the receptacle housing 106. A cover opening 110 is defined by the base 102 and provides access to the receptacle housing 106 such that a passageway is provided through the enclosure cover 100 from the receptacle entrance 108, through the receptacle housing 106, and to the cover opening 110. A plurality of enclosure coupling apertures 112 are defined by the base 102 and located in a spaced apart orientation on the base 102 and adjacent the four corners of the base 102. A gasket channel 114 is defined by the base 102 and located on the enclosure engagement surface 102b between the perimeter of the cover opening 110 and the enclosure engagement surface edge 102ba. In an exemplary embodiment, the gasket channel 114 is fabricated in the enclosure cover 100 by a molding process known in the art. The gasket channel 114 includes an arcuate section 114a at each of the four corners of the gasket channel 114, each arcuate section 114a located adjacent an enclosure coupling aperture 112. A first flame path surface 116 is located on the enclosure engagement surface 102b and extends from the perimeter of the gasket channel 114 to a minimum width of uninterrupted surface that is defined by a volume of an enclosure housing defined by an enclosure that the enclosure cover 100 is designed to couple to, which will be discussed in more detail below. In an exemplary embodiment, a portion of the first flame path surface 116 extends between the gasket channel 114 and the enclosure engagement surface edge 102ba and a portion of the first flame path surface 116 extends between the gasket channel 114 and the enclosure coupling apertures 112, as illustrated in FIG. 1c. In an exemplary embodiment, the minimum width of the first flame path surface 116 is ⅜ of an inch. In an exemplary embodiment, the enclosure cover 100 is designed to couple to a conventional back box enclosure in order to provide a retrofit enclosure cover for existing back box enclosures. In an exemplary embodiment, the enclosure cover 100 is fabricated from die cast aluminum.

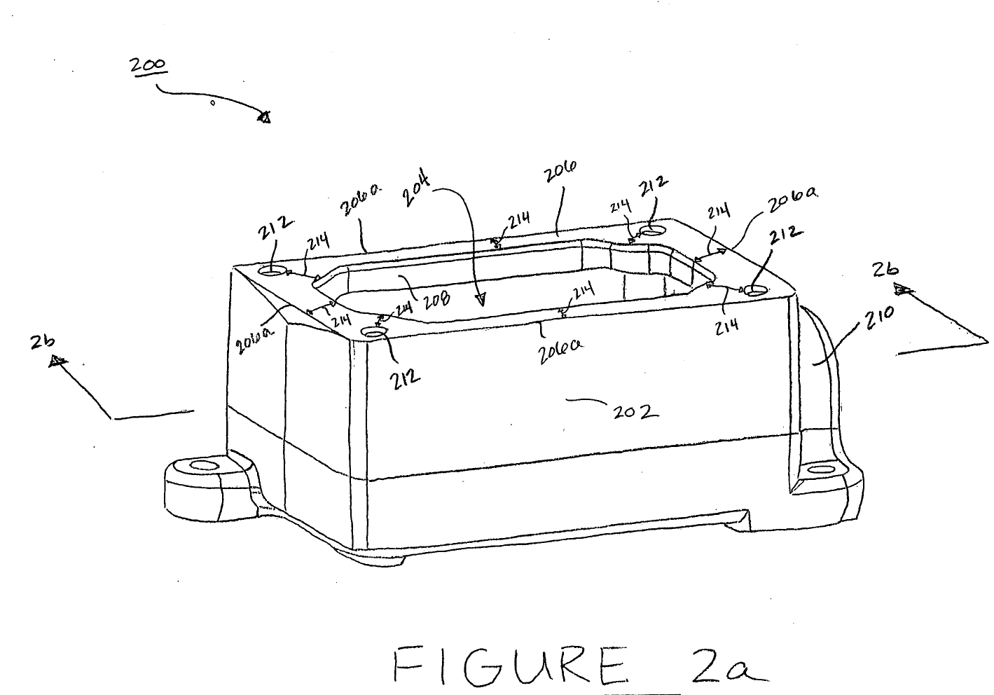

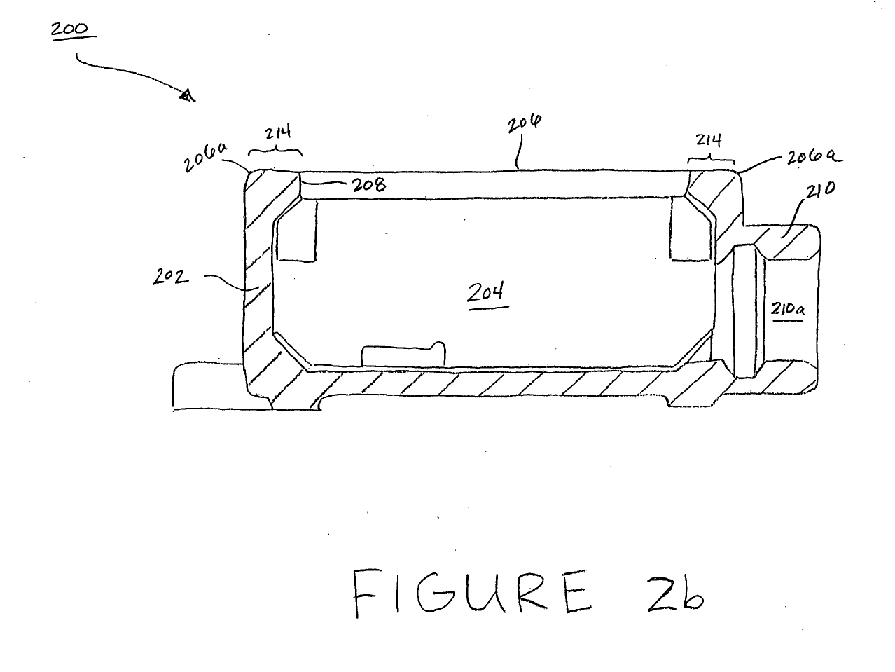

Referring now to FIGS. 2a and 2b, a conventional back box enclosure 200 is illustrated. The back box enclosure 200 includes a base 202 that defines an enclosure housing 204 and includes a cover engagement surface 206. In an exemplary embodiment, the back box enclosure 200 is fabricated from a metallic material such that the cover engagement surface 206 includes a metal surface. The cover engagement surface 206 includes an enclosure engagement surface edge 206a about its perimeter. An enclosure entrance 208 is defined by the base 202, located adjacent the cover engagement surface 206, and provides access to the enclosure housing 204. A conduit member 210 extends from a side of the base 102 and defines a conduit passageway 210a which provides access to the enclosure housing 204 though the base 102. In an exemplary embodiment, the base 102 may include a plurality of conduit members extending from the sides of the base 102 which are substantially similar to the conduit member 210 and which include passageways that provide access to the enclosure housing 204. A plurality of cover coupling apertures 212 are defined by the base 202 and are located on the cover engagement surface 206 adjacent the four corners of the cover engagement surface 206. In an exemplary embodiment, the cover coupling apertures 212 include threaded channels for coupling to conventional threaded fasteners known in the art. A second flame path surface 214 is located on the cover engagement surface 206 and extends from the perimeter of the enclosure entrance 208 to a minimum width of uninterrupted surface that is defined by the volume of the 204 enclosure housing, which will be discussed in more detail below. In an exemplary embodiment, a portion of the second flame path surface 214 extends between the enclosure entrance 208 and the cover engagement surface edge 206a and a portion of the second flame path surface 214 extends between the enclosure entrance 208 and the cover coupling apertures 212. In an exemplary embodiment, the minimum width of the second flame path surface 214 is ⅜ of an inch. In an exemplary embodiment, the conventional back box enclosure is a back box enclosure available from Cooper Crouse-Hinds, P.O. Box 4999, Syracuse, N.Y., 13221, http://www.crouse-hinds.com/ such as, for example, model numbers EFSC171, EFSC271, and/or EFSC371.

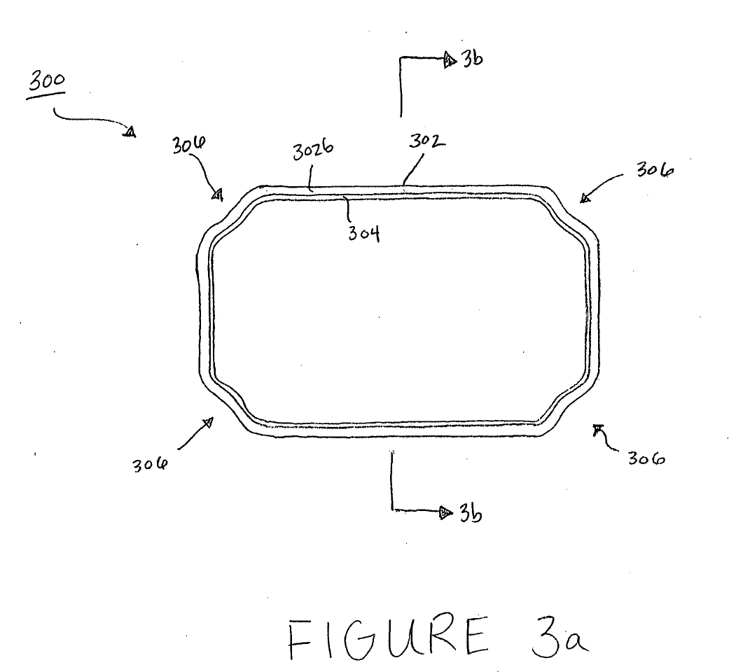

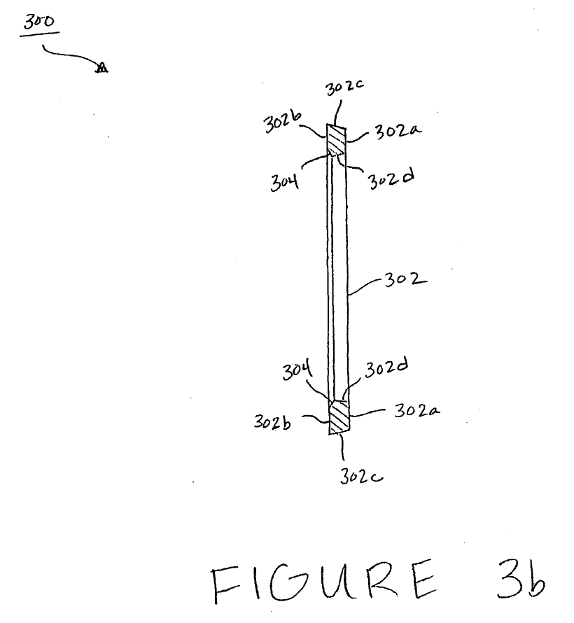

Referring now to FIGS. 3a and 3b, a gasket 300 is illustrated. The gasket 300 includes a substantially rectangular-shaped base 302 having a top surface 302a, a bottom surface 302b located opposite the top surface 302a, a side surface 302c extending between the top surface 302a and the bottom surface 302b, and a side surface 302d extending from the top surface 302a and located opposite the side surface 302c. A chamfered surface 304 extends between the bottom surface 302b and the side surface 302d. An arcuate section 306 on the gasket 300 is located at the four corners of the rectangular-shaped base 302. In an exemplary embodiment, the gasket 300 is fabricated from molded neoprene rubber.

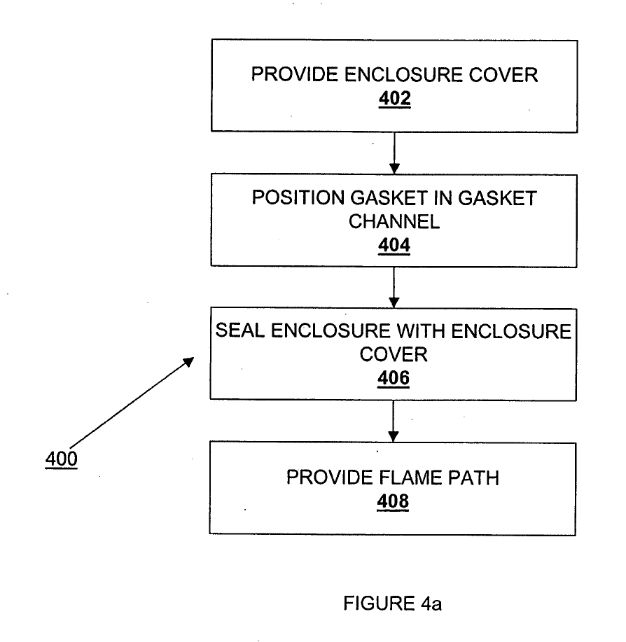

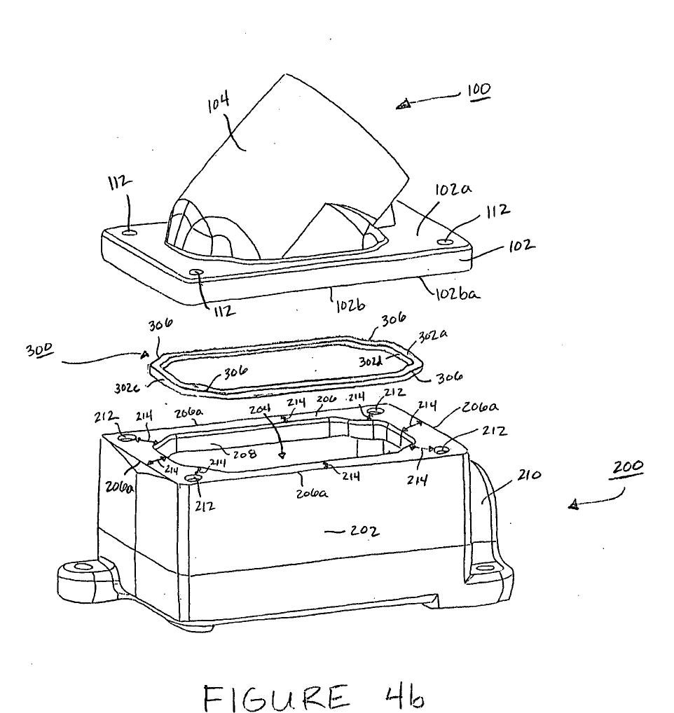

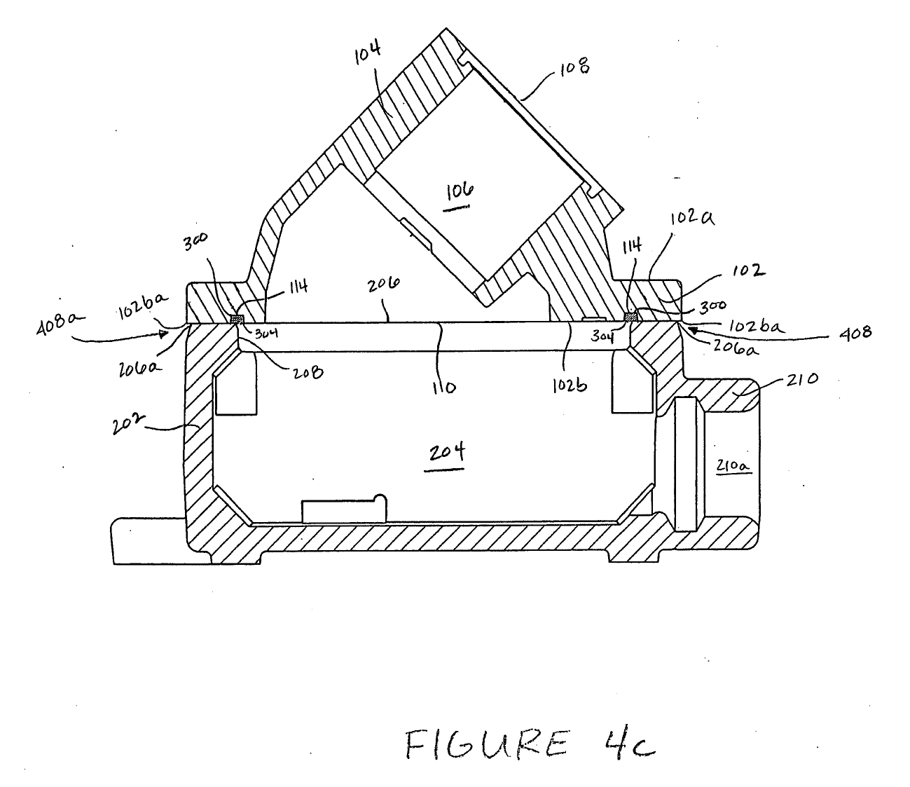

Referring now to FIGS. 1b, 1c, 2b, 3b, 4a, 4b, and 4c, a method 400 for sealing an enclosure is illustrated. The method 400 begins at step 402 wherein the enclosure cover 100 defining the gasket channel 114 is provided. The method 400 then proceeds to step 404 where the gasket 300 is positioned in the gasket channel 114. The gasket 300 is positioned adjacent the enclosure cover 100 such that the top surface 302a of the gasket 300 is adjacent the gasket channel 114 on enclosure engagement surface 102b, as illustrated in FIG. 4b. The gasket 300 may then be positioned in the gasket channel 114 such that the top surface 302 and the side surfaces 302c and 302d of the gasket 300 engage the edges of the gasket channel 114 and the bottom surface 302b and a portion of the chamfered surface 304 extend out of the gasket channel 114 and past the enclosure engagement surface 102b.

The method 400 then proceeds to step 406 where the enclosure 200 is sealed with the enclosure cover 100. The enclosure cover 100 with the gasket 300 positioned in the gasket channel 114 is positioned adjacent the enclosure 200 such that the enclosure engagement surface 102b is adjacent the cover engagement surface 206 on the enclosure 200 and the enclosure coupling apertures 112 on the enclosure cover 100 are aligned with respective cover coupling apertures 212 on the enclosure 200, as illustrated in FIG. 4b. The enclosure cover 100 is coupled to the enclosure 200 by engaging the enclosure engagement surface 102b on the enclosure cover 100 with the cover engagement surface 206 on the enclosure 200 and then positioning fasteners (not shown) in the enclosure coupling apertures 112 on the enclosure cover 100 and the cover coupling apertures 212 on the enclosure 200. With the enclosure cover 100 coupled to the enclosure 100, the gasket 100 engages the cover engagement surface 206 about the perimeter of the enclosure entrance 208, as illustrated in FIGS. 4b and 4c, providing a seal between the enclosure cover 100 and the enclosure 200. The method then proceeds to step 408 where a flame path is provided. The coupling of the enclosure cover 100 and the enclosure 200 defines a flame path 408a between the first flame path surface 116 on the enclosure cover 100 and the second flame path surface 214 on the enclosure 200. In an exemplary embodiment, the flame path 408a includes dimensions which allow a flame to cool as it escapes the enclosure housing 204 and the receptacle housing 106 between the metal surfaces of the enclosure engagement surface 102b and the cover engagement surface 206, the dimensions which are determined by the volume of the enclosure housing 204 and the receptacle housing 106 based on Underwriters Laboratories (UL) standards (www.ul.com). In an exemplary embodiment, the flame path 408a is defined by a minimum ⅜ of an inch uninterrupted metal first flame path surface 116 and a minimum ⅜ of an inch uninterrupted metal second flame path surface 214, resulting in a ⅜ of an inch flame path 408a.

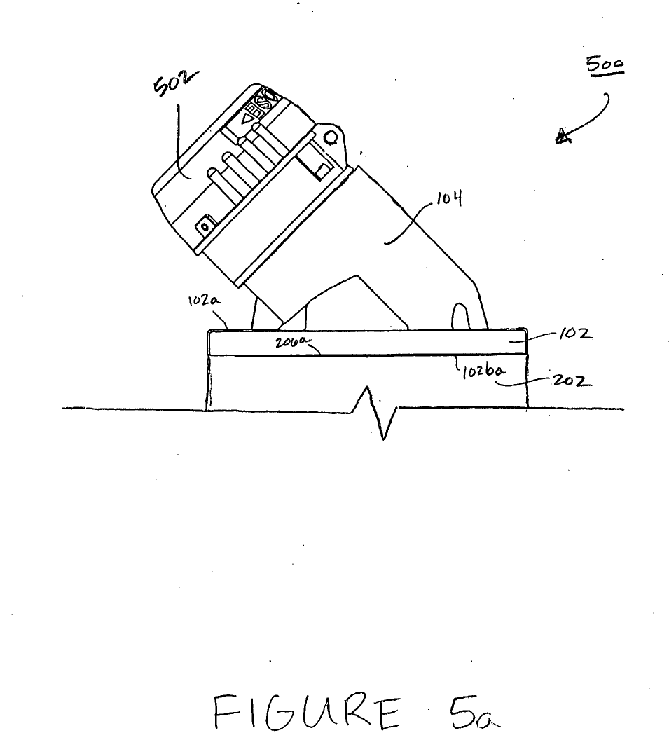

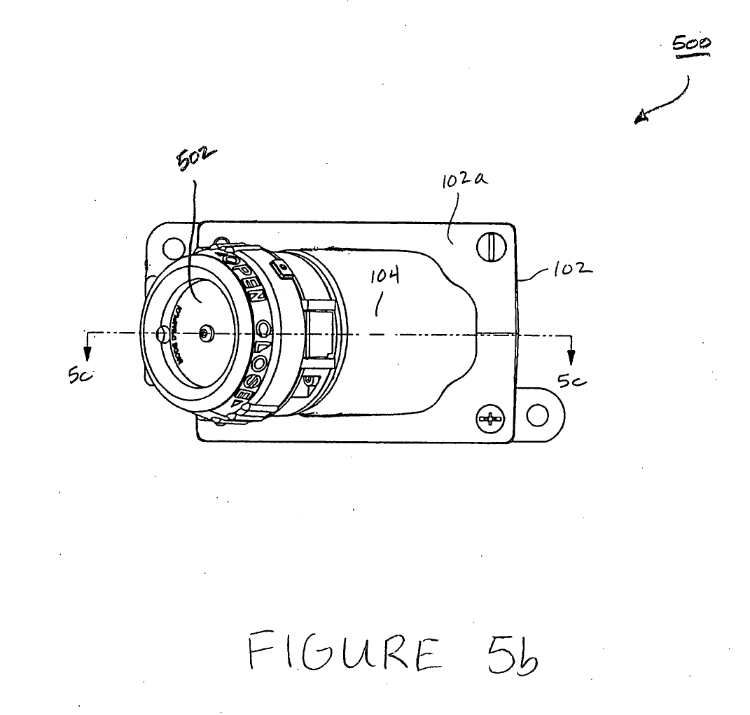

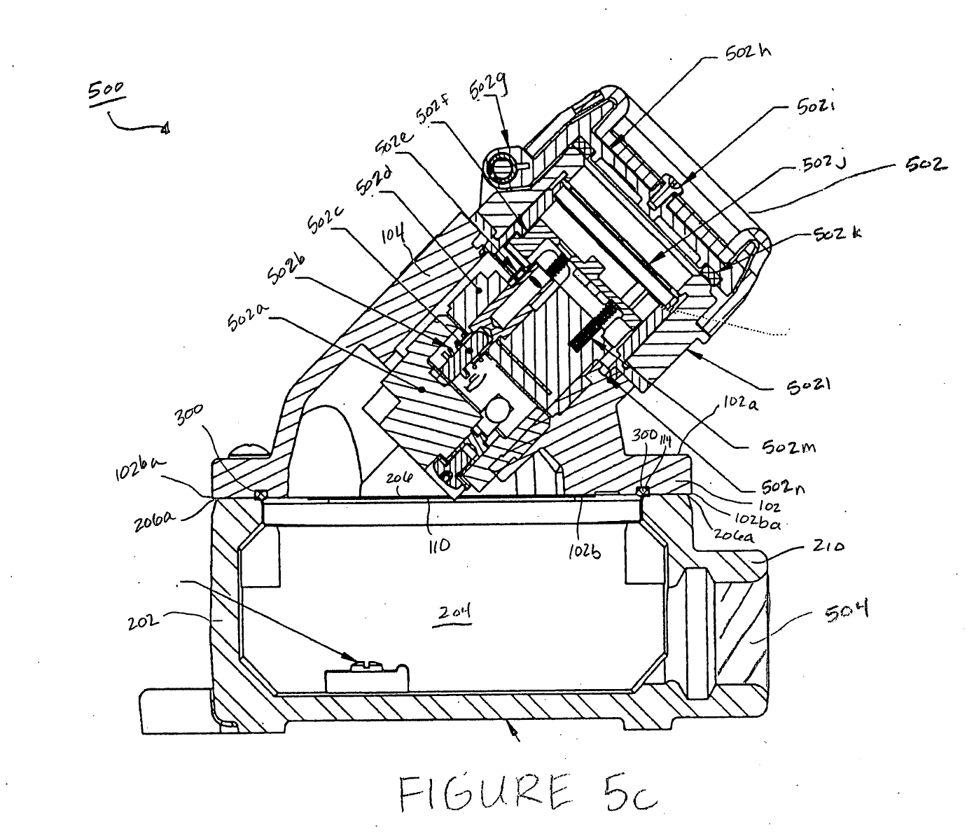

Referring now to FIGS. 5a, 5b, and 5c, in an exemplary experimental embodiment, an apparatus 500 was assembled as per method 400 with the provision of a conventional receptacle 502 positioned in the receptacle housing 106 and coupled to the enclosure cover 100 and a conduit cover 504 positioned in the conduit passageway 210a and coupled to the enclosure 200, as illustrated in FIGS. 5a, 5b, and 5c. In an exemplary embodiment, the conventional receptacle 502 is a receptacle available from Cooper Crouse-Hinds, P.O. Box 4999, Syracuse, N.Y., 13221, http://www.crouse-hinds.com/ such as, for example, model numbers ENR4201 and/or ENR6202. In an exemplary embodiment, the conventional receptacle is operable to receive a conventional electrical connector such as, for example, a plug. In an exemplary embodiment, the conventional receptacle 502 includes a lower contact body 502a, a ground spring 502b located adjacent the lower contact body 502a, a ground contact 502c located adjacent the ground spring 502b, an upper contact body 502d located adjacent the ground contact 502c, a ground spring clip 502e located adjacent the upper contact body 502d, a lock plate 502f located adjacent the ground spring clip 502e, a cap hinge 502g located adjacent the lock plate 502f, a cap spacer 502h located adjacent the cap hinge 502g, a pivot screw 502i located adjacent the cap spacer 502h, a plug gasket 502j located adjacent the pivot screw 502i, a cap gasket 502k located adjacent the plug gasket 502j, a body 502l located adjacent the cap gasket 502k, block spring 502m located adjacent the body 502l, and an O-ring 502n located adjacent the block spring 502m, as illustrated in FIG. 5c. A model number EFSC371 back box available from Cooper Crouse-Hinds, P.O. Box 4999, Syracuse, N.Y., 13221, http://www.crouse-hinds.com/, was used at the enclosure 200.

In the exemplary experimental embodiment, the apparatus 500 was subjected to a Type 4 Hose test per UL50, paragraph 35.2, dated Nov. 19, 1999. A stream of water from a 1-inch diameter nozzle at 5 PSI/65 gpm was directed at the apparatus 500 at a distance of 10 feet for 5 minutes. The interior of the apparatus 500 was powdered. The apparatus was also Type 3R rain tested per EN2914. At the conclusion of the testing, no water was observed in the apparatus 500 housing which includes the enclosure housing 204 and the receptacle housing 106. Thus, by the standards set by the National Electrical Manufacturers Association (NEMA), the apparatus 500 passed the NEMA 4 test. This was an unexpected result. Thus, an enclosure cover 100 is provided which may be coupled to conventional back box enclosures in order to provide a seal between the back box enclosure and the enclosure cover 100 that will pass the NEMA 4 test. The enclosure cover 100 provides a retrofit for existing conventional back box enclosures already existing in the field that maintains the required flame path dimensions by UL standards while providing a NEMA 4 rating. Furthermore, the gasket channel 114 may be manufactured using a molding process, which is cheaper than traditional machining processes.

It is understood that variations may be made in the foregoing without departing from the scope of the disclosure.

Any foregoing spatial references such as, for example, “upper,” “lower,” “above,” “below,” “rear,” “between,” “vertical,” “angular,” etc., are for the purpose of illustration only and do not limit the specific orientation or location of the structure described above.

In several exemplary embodiments, it is understood that one or more of the operational steps in each embodiment may be omitted. Moreover, in some instances, some features of the present disclosure may be employed without a corresponding use of the other features. Moreover, it is understood that one or more of the above-described embodiments and/or variations may be combined in whole or in part with any one or more of the other above-described embodiments and/or variations.

Although exemplary embodiments of this disclosure have been described in detail above, those skilled in the art will readily appreciate that many other modifications, changes and/or substitutions are possible in the exemplary embodiments without materially departing from the novel teachings and advantages of this disclosure. Accordingly, all such modifications, changes and/or substitutions are intended to be included within the scope of this disclosure as defined in the following claims. In the claims, means-plus-function clauses are intended to cover the structures described herein as performing the recited function and not only structural equivalents, but also equivalent structures.

What is claimed is:

1. An enclosure sealing apparatus, comprising:
an enclosure cover defining a cover opening;
a enclosure engagement surface located on the enclosure cover and extending between the perimeter of the cover opening and an enclosure engagement surface edge; and
a gasket channel defined by the enclosure cover and located on the enclosure engagement surface between the perimeter of the cover opening and the enclosure engagement surface edge, wherein the enclosure engagement surface comprises a first flame path surface immediately adjacent the gasket channel, whereby the first flame path surface has a minimum width corresponding to a volume of an enclosure housing defined by an enclosure that the enclosure cover is designed to couple to.

2. The apparatus of claim 1, wherein the enclosure cover is operable to couple to a conventional back box enclosure.

3. The apparatus of claim 1, wherein the minimum width of the first flame path surface is ⅜ of an inch.

4. The apparatus of claim 1, further comprising:
a receptacle entrance defined by the enclosure cover; and
a receptacle housing defined by the enclosure cover, whereby the receptacle entrance and the cover opening each provide access to the receptacle housing.

5. The apparatus of claim 1, further comprising:
a plurality of enclosure coupling apertures defined by the enclosure cover and located in a spaced apart orientation on the enclosure engagement surface.

6. The apparatus of claim 5, wherein the gasket channel comprises an arcuate section located adjacent each enclosure coupling aperture such that the first flame path surface immediately adjacent the gasket channel comprises the minimum width between the gasket channel and the enclosure coupling aperture.

7. The apparatus of claim 1, wherein the gasket channel is molded in the enclosure cover.

8. The apparatus of claim 1, further comprising:
a gasket located in the gasket channel.

9. The apparatus of claim 8, wherein the enclosure cover and the gasket are operable to be coupled to a conventional back box enclosure in order to provide a liquid tight seal having a NEMA 4 rating between the enclosure cover and the back box enclosure.

10. The apparatus of claim 8, further comprising:
an enclosure defining an enclosure housing and an enclosure entrance that provides access to the enclosure housing; and
a cover engagement surface located on the enclosure and extending between the perimeter of the enclosure entrance and a cover engagement surface edge, whereby the enclosure cover is coupled to the enclosure such that the gasket engages the cover engagement surface.

11. The apparatus of claim 10, wherein the cover engagement surface comprises a second flame path surface located immediately adjacent the perimeter of the enclosure entrance, wherein the second flame path surface has a minimum width corresponding to the volume of the enclosure housing, whereby the first flame path surface on the enclosure cover and the second flame path surface on the enclosure define a flame path between the enclosure cover and the enclosure having a minimum width corresponding the volume of the enclosure housing.

12. The apparatus of claim 11, wherein the minimum width of the second flame path surface is ⅜ of an inch.

13. The apparatus of claim 11, wherein the minimum width of the flame path is ⅜ of an inch.

14. The apparatus of claim 10, wherein the gasket engages the cover engagement surface immediately adjacent the perimeter of the enclosure entrance.

15. The apparatus of claim 10, wherein the engagement of the gasket and the cover engagement surface provides a liquid tight seal having a NEMA 4 rating between the enclosure cover and the enclosure.

16. The apparatus of claim 10, further comprising:
a receptacle coupled to the enclosure cover.

17. An enclosure sealing apparatus, comprising:
means for covering an enclosure;
means for positioning a means for providing a seal between the means for covering an enclosure and an enclosure located on the means for covering an enclosure; and
first means for providing a path to cool a flame located on the means for covering an enclosure.

18. The apparatus of claim 17, wherein the means for covering an enclosure is operable to couple to a conventional back box enclosure.

19. The apparatus of claim 17, wherein the first means for providing a path to cool a flame comprises an uninterrupted surface of at least ⅜ of an inch.

20. The apparatus of claim 17, further comprising:
means for housing a receptacle defined by the means for covering an enclosure.

21. The apparatus of claim 17, further comprising:
means for coupling the means for covering an enclosure to an enclosure located on the means for covering an enclosure.

22. The apparatus of claim 17, wherein the means for positioning a means for providing a seal between the means for covering an enclosure and an enclosure is molded in the means for covering an enclosure.

23. The apparatus of claim 17, further comprising:
means for providing a seal located in the means for positioning a means for providing a seal between the means for covering an enclosure and an enclosure.

24. The apparatus of claim 23, wherein the means for covering an enclosure and the means for providing a seal are operable to be coupled to a conventional back box enclosure in order to provide a liquid tight seal having a NEMA 4 rating between the means for covering an enclosure and the conventional back box enclosure.

25. The apparatus of claim 23, further comprising:
an enclosure, whereby the means for covering an enclosure is coupled to the enclosure such that the means for providing a seal engages the enclosure.

26. The apparatus of claim 25, further comprising:
second means for providing a path to cool a flame located on the enclosure, whereby the first means for providing a path to cool a flame on the means for covering an enclosure and the second means for providing a path to cool a flame on the enclosure define a means for cooling a flame between the means for covering an enclosure and the enclosure having a minimum width corresponding the volume of an enclosure housing defined by the enclosure.

27. The apparatus of claim 26, wherein the second means for providing a path to cool a flame comprises an uninterrupted surface of at least ⅜ of an inch.

28. The apparatus of claim 26, wherein the minimum width of the means for cooling a flame is ⅜ of an inch.

29. The apparatus of claim 25, wherein the engagement of the means for providing a seal and the enclosure provides a liquid tight seal having a NEMA 4 rating between the means for covering an enclosure and the enclosure.

30. The apparatus of claim 25, further comprising:
means for receiving an electrical connector coupled to the means for covering an enclosure.

31. A method for sealing an enclosure comprising:
providing an enclosure cover defining a gasket channel;
positioning a gasket in the gasket channel;
sealing an enclosure by coupling the enclosure cover to the enclosure such that the gasket engages the enclosure; and
providing a flame path defined between the enclosure cover and the enclosure and located adjacent the gasket.

32. The method of claim 31, wherein the sealing comprising providing a liquid tight seal having a NEMA 4 rating between the enclosure and the enclosure cover.

33. An enclosure sealing apparatus, comprising:
an enclosure cover defining a receptacle housing, a cover opening, and a receptacle entrance, wherein the cover opening and the receptacle entrance each provide access to the receptacle housing, whereby the enclosure cover is operable to couple to a conventional back box enclosure;
a enclosure engagement surface located on the enclosure cover and extending between the perimeter of the cover opening and an enclosure engagement surface edge;
a gasket channel defined by the enclosure cover and located on the enclosure engagement surface between the perimeter of the cover opening and the enclosure engagement surface edge, wherein the enclosure engagement surface comprises a first flame path surface immediately adjacent the gasket channel, whereby the first flame path surface has a minimum width of ⅜ of an inch; and
a plurality of enclosure coupling apertures defined by the enclosure cover and located in a spaced apart orientation on the enclosure engagement surface, wherein the gasket channel comprises an arcuate section located adjacent each enclosure coupling aperture such that the first flame path surface immediately adjacent the gasket channel comprises the minimum width between the gasket channel and the enclosure coupling aperture.

34. The apparatus of claim 33, further comprising:
a gasket located in the gasket channel.
an enclosure defining an enclosure housing and an enclosure entrance that provides access to the enclosure housing;
a cover engagement surface located on the enclosure and extending between the perimeter of the enclosure entrance and a cover engagement surface edge, wherein the enclosure cover is coupled to the enclosure such that the gasket engages the cover engagement surface immediately adjacent the perimeter of the enclosure entrance and provides a liquid tight seal having a NEMA 4 rating between the enclosure cover and the enclosure, whereby the cover engagement surface comprises a second flame path surface located immediately adjacent the perimeter of the enclosure entrance, wherein the second flame path surface has a minimum width of ⅜ of an inch, whereby the first flame path surface on the enclosure cover and the second flame path surface on the enclosure define a flame path between the enclosure cover and the enclosure having a minimum width of ⅜ of an inch; and
a receptacle coupled to the enclosure cover.

35. An enclosure sealing apparatus, comprising:
means for covering an enclosure operable to couple to a conventional back box enclosure;
means for housing a receptacle defined by the means for covering an enclosure;
means for coupling the means for covering an enclosure to an enclosure located on the means for covering an enclosure;
means for positioning a means for providing a seal between the means for covering an enclosure and an enclosure located on the means for covering an enclosure; and
first means for providing a path to cool a flame located on the means for covering an enclosure.

36. The apparatus of claim 35, further comprising:
means for providing a seal located in the means for positioning a means for providing a seal between the means for covering an enclosure and an enclosure;
an enclosure, wherein the means for covering an enclosure is coupled to the enclosure such that the means for providing a seal engages the enclosure, whereby the engagement of the means for providing a seal and the enclosure provides a liquid tight seal having a NEMA 4 rating between the means for covering an enclosure and the enclosure;
second means for providing a path to cool a flame located on the enclosure, whereby the first means for providing a path to cool a flame on the means for covering an enclosure and the second means for providing a path to cool a flame on the enclosure define a means for cooling a flame between the means for covering an enclosure and the enclosure having a minimum width corresponding the volume of an enclosure housing defined by the enclosure; and
means for receiving an electrical connector coupled to the means for covering an enclosure.

37. A method for sealing an enclosure comprising:
providing an enclosure cover defining a gasket channel;
positioning a gasket in the gasket channel;
sealing an enclosure by coupling the enclosure cover to the enclosure such that the gasket engages the enclosure, wherein the sealing comprising providing a liquid tight seal having a NEMA 4 rating between the enclosure and the enclosure cover; and
providing a flame path defined between the enclosure cover and the enclosure and located adjacent the gasket.
